(19) United States
(12) Patent Application Publication
(10) Pub. No.: US 2007/0116360 A1
(43) Pub. Date: May 24, 2007

(54) Apparatus and method for detecting character region in image

(75) Inventors: Cheolkon Jung, Suwon-si (KR); Youngsu Moon, Seoul (KR); Lui Qi Feng, Beijing (CN); Jiyeun Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/594,827

(22) Filed: Nov. 9, 2006

(30) Foreign Application Priority Data
Nov. 21, 2005 (KR) 10-2005-111432

(51) Int. Cl. G06K 9/34

(52) U.S. Cl. 382/176; 382/171

(57) ABSTRACT

An apparatus and method for detecting a character region in an image. The apparatus includes a character candidate region detecting unit which detects a character candidate region from the image by detecting character strokes; and a character region checking unit which checks whether the detected character candidate region is the character region in response to the detected result of the character candidate region detecting unit.

### CROSS-REFERENCE TO RELATED APPLICATIONS

This application claims the benefit of Korean Patent Application No. 10-2005-0111432, filed on Nov. 21, 2005, in the Korean Intellectual Property Office, the disclosure of which is incorporated herein in its entirety by reference.

### BACKGROUND OF THE INVENTION

1. Field of the Invention

The present invention relates to detection of a character region in an image, and more particularly, to an apparatus and method for detecting a character region in an image using a stroke filter.

2. Description of the Related Art

Since characters contained in the subtitle of a video or an image include meaningful information, recognition of the characters in the subtitle is very important in order to provide a digital contents management (DCM) service. In other words, the recognition of the characters in a subtitle is used in various DCM services such as motion picture summary, motion picture search, scene detection, and character-based mobile services. In order to recognize the characters in a subtitle, a region in which the subtitle's characters are positioned must be first detected.

Conventional technologies for detecting a character region include a method of detecting a character region based on edge or color characteristics of an image, a method of generating a single machine learning classifier based on constant gradient variance (CGV), gray, or gradient and detecting a character region based on the single machine learning classifier, and a method of detecting character regions based on machine learning in each pyramid level using a multi-resolution method and simply unifying the detected results to detect a final character region.

However, in the method of detecting the character region only using the edge or color characteristics, there is a limit in distinguishing between a background region and the character region and thus wrong detection or non-detection may be generated. Furthermore, in the method of detecting the character region using the single classifier the performance of detecting the character region is quite low and thus a plurality of classifiers must be used. In the method of detecting the character region using machine learning in each pyramid level, since the region detecting process and the hierarchical unifying and detecting process need be efficiently performed, a process speed may be reduced.

### SUMMARY OF THE INVENTION

The present invention provides an apparatus and method for detecting a character region in an image, wherein an optimal character region is detected using a stroke filter.

According to an aspect of the present invention, there is provided an apparatus for detecting a character region in an image, including a character candidate region detecting unit which detects a character candidate region from the image by detecting character strokes; and a character region checking unit which checks whether the detected character candidate region is the character region in response to the detected result of the character candidate region detecting unit.

According to another aspect of the present invention, there is provided a method for detecting a character region in an image, including detecting a character candidate region from the image by detecting character strokes; and checking whether the detected character candidate region is the character region.

Additional aspects and/or advantages of the invention will be set forth in part in the description which follows and, in part, will be apparent from the description, or may be learned by practice of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for detecting a character region in an image according to an embodiment of the present invention;

FIG. 2 is a block diagram of a character candidate region detecting unit illustrated in FIG. 1;

FIGS. 3A and 3B illustrate an example of character strokes of a Korean character;

FIGS. 4A and 4B illustrate an example of character strokes of an English character;

FIG. 5 illustrates an example of a character stroke filter;

FIGS. 6A and 6B illustrate an example of readjusting a character stroke region and representing the readjusted character stroke region by a histogram;

FIG. 7 is a block diagram of a character region checking unit illustrated in FIG. 1;

FIG. 8 is a block diagram of a feature value detecting unit illustrated in FIG. 7;

FIGS. 9A-9C illustrate an example of partial regions obtained by dividing a detected character candidate region using a window having a predetermined size;

FIG. 10 is a block diagram of a boundary correcting unit illustrated in FIG. 1;

FIG. 11 illustrates an example of reducing a boundary line of the character region by a boundary line reducing unit illustrated in FIG. 10;

FIG. 12 is a block diagram of a boundary line coupling unit illustrated in FIG. 10;

FIG. 13 is a view for explaining components in the boundary line coupling unit;

FIGS. 14A and 14B are views for explaining a boundary line expanding unit;

FIG. 15 is a flowchart illustrating a method of detecting a character region in an image according to an embodiment of the present invention;

FIG. 16 is a flowchart illustrating operation 702 illustrated in FIG. 15;

FIG. 17 is a flowchart illustrating operation 704 illustrated in FIG. 15;

FIG. 18 is a flowchart illustrating operation 900 illustrated in FIG. 17;

FIG. 19 is a flowchart illustrating operation 708 illustrated in FIG. 15; and

FIG. 20 is a flowchart illustrating operation 1012 illustrated in FIG. 19.

### DETAILED DESCRIPTION OF THE PREFERRED EMBODIMENTS

Hereinafter, an apparatus for detecting a character region in an image according to an embodiment of the present invention will be described with reference to the accompanying drawings.

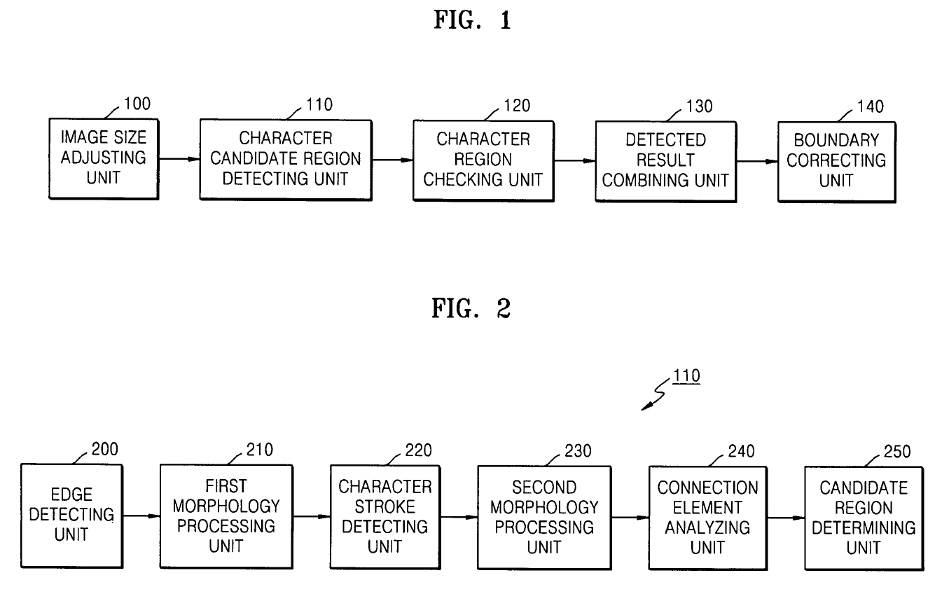

FIG. 1 is a block diagram of an apparatus for detecting a character region in an image according to an embodiment of the present invention. The apparatus includes an image size adjusting unit 100, a character candidate region detecting unit 110, a character region checking unit 120, and a detected result combining unit 130, and a boundary correcting unit 140.

The image size adjusting unit 100 adjusts the size of an image and outputs the adjusted result to the character candidate region detecting unit 110. The image size adjusting unit 100 may enlarge or reduce an original image.

The character candidate region detecting unit 110 detects character strokes from the image having the adjusted size, detects a character candidate region from the image having the adjusted size, and outputs the detected result to the character region checking unit 120.

FIG. 2 is a block diagram of the character candidate region detecting unit 110 illustrated in FIG. 1. The character candidate region detecting unit 110 includes an edge detecting unit 200, a first morphology processing unit 210, a character stroke detecting unit 220, a second morphology processing unit 230, a connection element analyzing unit 240, and a candidate region determining unit 250.

The edge detecting unit 200 detects an edge from the image having the adjusted size and outputs the detected result to the first morphology processing unit 210. The edge corresponds to a portion having a large contrast difference.

The first morphology processing unit 210 performs a morphology process on the detected edge and outputs the performed result to the character stroke detecting unit 220. The morphology process relates to a morphology image processing method and is used for clarifying image preprocessing, initial object classification, or an intrinsic structure of an object and extracting an image element useful to represent a form such as a boundary or a frame. The morphology process includes dilation and erosion. The dilation means that a bright portion is enlarged more than the existing image, and the erosion means that a dark portion is enlarged more than the existing image. The first morphology processing unit 210 dilates or erodes the edge by performing the morphology process on the detected edge.

The character stroke detecting unit 220 detects the character strokes from the morphology-processed image and outputs the detected result to the second morphology processing unit 230. Each Korean character or English character is made using a plurality of strokes.

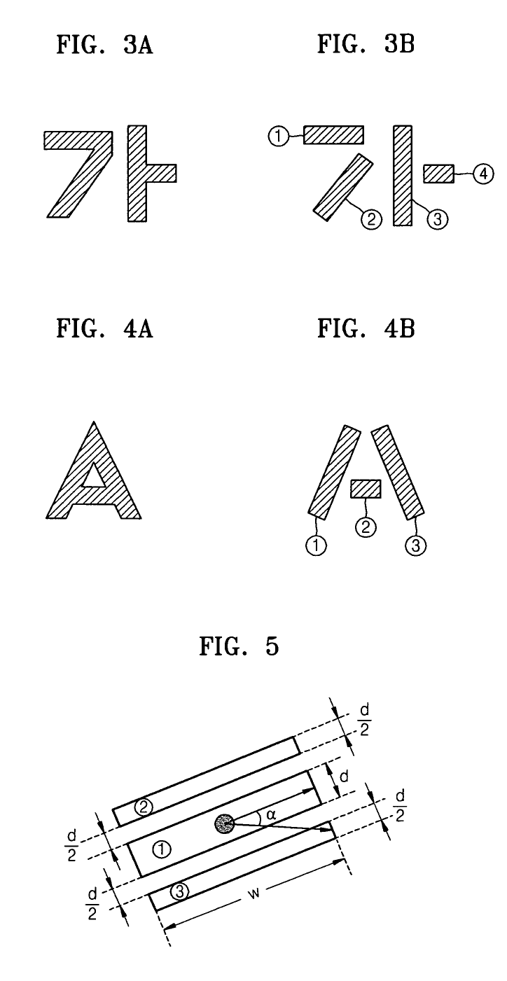

FIGS. 3A and 3B illustrate an example of character strokes of a Korean character, and FIGS. 4A and 4B illustrate an example of character strokes of an English character. The character strokes of Korean character illustrated in FIG. 3A correspond to 31 through 34 illustrated in FIG. 3B, and the character strokes of English character illustrated in FIG. 4A correspond to 41 through 41 illustrated in FIG. 4B.

The character stroke detecting unit 220 detects the character strokes using a character stroke filter, while scanning the image. The character stroke detecting unit 220 detects the character strokes from values of pixels included in the character stroke filter.

FIG. 5 illustrates an example of the character stroke filter. As illustrated in FIG. 5, the character stroke filter has a set of a first filter 51, a second filter 52, and a third filter 53, each having a rectangular shape.

When the vertical width of the first filter 51 is d, the vertical widths of the second filter 52 and the third filter 53 are half of the that of the first filter 51. Furthermore, a distance between the first filter 51 and the second filter 52 is half of the vertical width of the first filter 51, and the distance between the first filter 51 and the third filter 53 is half of the vertical width of the first filter 51. However, these conditions are only exemplary and filters having various sizes may be used.

The character stroke detecting unit 220 detects the character strokes while varying the angle of the character stroke filter. For example, the character stroke detecting unit 220 detects the character strokes from the values of the pixels included in the character stroke filter whenever the character stroke filter rotates by 0 degree, 45 degrees, 90 degrees, and 135 degrees.

Meanwhile, the character stroke detecting unit 220 detects the character strokes while varying the size of the character stroke filter. For example, the character stroke detecting unit 220 detects the character strokes while varying the sizes such as the horizontal widths or the vertical widths of the first filter 51, the second filter 52, and the third filter 53.

The character stroke detecting unit 220 detects a region in which a filtering value obtained by Equation 1 exceeds a first threshold value as the character strokes.

$${R}_{1} ( α , d ) = \frac{1}{\sqrt{{m}_{1}^{( 2 )}}} [ \begin{matrix}\vert {m}_{1}^{( 1 )} - {m}_{2}^{( 1 )} \vert + \\ \vert {m}_{1}^{( 1 )} - {m}_{3}^{( 1 )} \vert - \\ \vert {m}_{2}^{( 1 )} - {m}_{3}^{( 1 )} \vert\end{matrix} ] \qquad Equation 1$$

where, R(α, d) is the filtering value, α is an angle of the character stroke filter, d is the vertical width of the first filter, m₁⁽¹⁾ is an average of the values of the pixels included in the first filter, m₂⁽¹⁾ is an average of the values of the pixels included in the second filter, m₃⁽¹⁾ is an average of the values of the pixels included in the third filter, and m₁⁽²⁾ is a variance of the values of the pixels included in the first filter.

The first threshold value is a minimum value for determining that the image filtered by the character stroke filter is the character stroke, and uses a value previously obtained through repetitive experiments.

The second morphology processing unit 230 performs a morphology process on the detected character strokes and outputs the performed result to the connection element analyzing unit 240. The second morphology processing unit 230 dilates or erodes the character strokes through the morphology process.

The connection element analyzing unit 240 analyzes connection elements of character stroke regions occupied by the morphology-processed character strokes, readjusts the character stroke regions, and outputs the readjusted result to the candidate region determining unit 250.

The connection element analyzing unit 240 unifies adjacent character stroke regions into one character stroke region when a plurality of character stroke regions are adjacent to one another at the upper, lower, left, and right sides thereof.

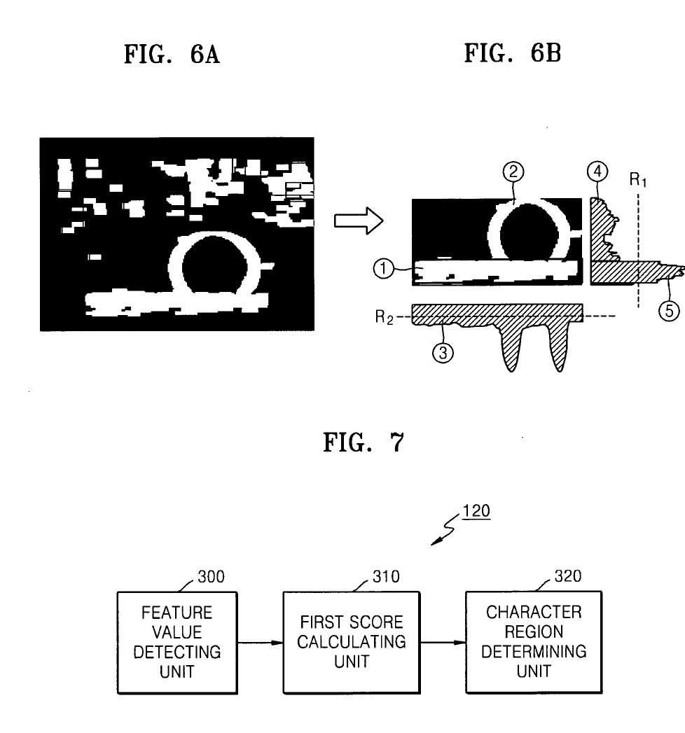

FIGS. 6A and 6B illustrate an example of readjusting the character stroke regions and representing the readjusted character stroke regions by a histogram. FIG. 6A illustrates the character stroke regions and FIG. 6B illustrates the readjusted character stroke regions and the histogram of these regions. As illustrated in FIG. 6B, when a plurality of character stroke regions are adjacent to one another at the upper, lower, left, and right sides thereof, the connection element analyzing unit 240 unifies adjacent character stroke regions into one character stroke region to form a larger region.

Furthermore, the connection element analyzing unit 240 excludes the character stroke region from the character candidate region, if pixel number of the character stroke region is less than a predetermined number.

As illustrated in FIG. 6B, the connection element analyzing unit 240 excludes the character stroke region of which the pixel number is less than the predetermined number (for example, 300) from the character candidate region. By excluding the character stroke region having a small pixel number by the connection element analyzing unit 240, the simplified character stroke region is formed as illustrated in FIG. 6B.

The candidate region determining unit 250 determines the character candidate region by orthogonally projecting the pixels of the readjusted character stroke region in vertical and horizontal directions.

The candidate region determining unit 250 determines the character stroke region which histogram results by orthogonally projecting the pixels of the character stroke region in the horizontal direction and the vertical direction exceed a first comparative value and a second comparative value as the character candidate region. As illustrated in FIG. 6B, the candidate region determining unit 250 detects the character stroke region 63 which exceeds a first comparative value R₁ among a histogram result 63 obtained by orthogonally projecting the pixels of the character stroke regions 61 and 62 in the horizontal direction. Also, the candidate region determining unit 250 detects the character stroke region 65 which exceeds a second comparative value R₂ among a histogram results 64 and 65 obtained by orthogonally projecting the pixels of the character stroke regions 61 and 62 in the vertical direction. Since, the candidate region determining unit 250 determines as the character candidate region the character stroke region 61, which simultaneously satisfies the detected character stroke region 63 and the detected character stroke region 65.

The character region checking unit 120 checks whether the detected character candidate region is the character region and outputs the checked result to the detected result combining unit 130 in response to the detected result of the character candidate region detecting unit 110.

FIG. 7 is a block diagram of the character region checking unit 120 illustrated in FIG. 1. The character region checking unit 120 includes a feature value detecting unit 300, a first score calculating unit 310, and a character region determining unit 320.

The feature value detecting unit 300 detects normalized intensity feature value and constant gradient variance (CGV) feature value of partial regions, which are obtained by dividing the detected character candidate region by a predetermined size. The normalized intensity feature value indicates a normalized value of the intensity of the partial region.

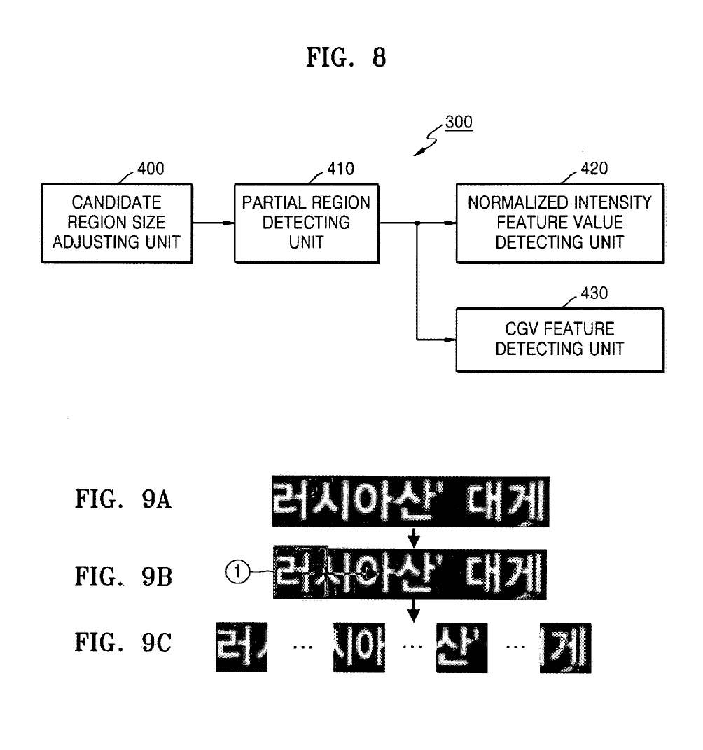

FIG. 8 is a block diagram of the feature value detecting unit 300 illustrated in FIG. 7. The feature value detecting unit 300 includes a candidate region size adjusting unit 400, a partial region detecting unit 410, a normalized intensity feature value detecting unit 420, and a CGV feature value detecting unit 430.

The candidate region size adjusting unit 400 adjusts the size of the detected character candidate region and outputs the adjusted result to the partial region detecting unit 410. For example, the candidate region size adjusting unit 400 adjusts the size of the detected character candidate region to a vertical width of 15 pixels.

The partial region detecting unit 410 detects the partial regions of the character candidate region using a window having a predetermined size and outputs the detected result to the normalized intensity feature value detecting unit 420 and the CGV feature value detecting unit 430.

FIGS. 9A-9C illustrate an example of the partial regions obtained by dividing a detected character candidate region using the window having the predetermined size. FIG. 9A illustrates the character candidate region detected by the character candidate region detecting unit 110, FIG. 9B illustrates a procedure of scanning the character candidate region using the window 91 having the predetermined size (for example, 15×15 pixels), and FIG. 9C illustrates the partial regions divided by the window having the predetermined size.

The normalized intensity feature value detecting unit 420 detects the normalized intensity feature values of the partial regions detected by the partial region detecting unit 410.

The normalized intensity feature value detecting unit 420 detects normalized intensity feature value components of the pixels of any partial region using Equation 2.
Nf(s)=(f(s)−Vₘᵢₙ)/(Vₘₐₓ−Vₘᵢₙ)*L Equation 2
where, Nf(s) is the normalized intensity feature value component of the pixel s in any partial region, f(s) is the intensity value of the pixel s, Vₘᵢₙ is a lowest intensity value among the intensity values of the pixels in any partial region, Vₘₐₓ is a highest intensity value among the intensity values of the pixels in any partial region, and L is a constant for normalizing the intensity value.

For example, if L is a constant of 255, the normalized intensity feature value component is normalized in a range of 0 to 255.

If the size of the partial region is 15×15 pixels, the partial region has 225 pixels. Accordingly, the number of the normalized intensity feature value components of each pixel is 225. Thus, 225 normalized intensity feature value components configure the normalized intensity feature value which is a vector value.

The CGV feature value detecting unit 430 detects the CGV feature values of the detected partial regions.

The CGV feature value detecting unit 430 detects the CGV feature value components of the pixels of any partial region using Equation 3.

$$CGV ( s ) = ( g ( s ) - LM ( s ) ) \sqrt{\frac{GV}{LV ( s )}} \qquad Equation 3$$

where, CGV(s) is the CGV feature value component of the pixel s in any partial region, g(s) is the gradient size of the pixel s, LM(s) is an average of the intensity values of the pixels in a predetermined range from the pixel s, LV(s) is a variance of the intensity values of the pixels in the predetermined range from the pixel s, and GV is a variance of the intensity values of the pixels in any partial region. The gradient size of the pixel s is obtained through a gradient filter. LM(s) is the average of the pixels included in a specific small region when a partial region is divided into small regions (for example, 9×9) centered on each pixel. LV(s) is the variance of the pixels included in a specific small region when a partial region is divided into small regions (for example, 9×9) centered on each pixel.

If the size of the partial region is 15×15 pixels, the partial region has 225 pixels. Accordingly, the number of the CGV feature value components of each pixel is 225. Thus, 225 CGV feature value components are transformed into the normalized intensity feature value, which is a vector.

Accordingly, the feature value detecting unit 300 detects the normalized intensity feature value and the CGV feature value, which are vectors, from one partial region.

The first score calculating unit 310 unifies the normalized intensity feature values and the CGV feature values of the partial regions, calculates character region determining scores of the partial regions, and outputs the calculated result to the character region determining unit 320.

The first score calculating unit 310 calculates the character region determining score of any partial region using Equation 4.
F₀=P₁ F₁+P₂F₂ Equation 4
where, F₀ is the character region determining score of any partial region, F₁ is an output score of support vector machine (SVM) of the normalized intensity feature value of any partial region, F₂ is an output score of support vector machine (SVM) of the CGV feature value of any partial region, P₁ is a pre-trained prior probability of the normalized intensity feature value, and P₂ is a pre-trained prior probability of the CGV feature value.

The prior probability P₁ randomizes classification performance obtained through repetitive training on the normalized intensity feature value and the prior probability P₂ randomizes classification performance obtained through repetitive training on the CGV feature value.

The output score of the SVM is obtained using Equation 5.

$$F = {\sum }_{i = 1}^{s} {α}_{{t}_{j}} {y}_{{t}_{j}} K ( {x}_{{t}_{j}} , z ) + b \qquad Equation 5$$

where, F is the output score of the SVM, αₜ, is a weight, yₜ is a label, K is Kernel, xₜⱼ is a feature value, z is a variable, and b is a constant.

The character region determining unit 320 compares an average of the character region determining scores of the partial regions calculated by the first score calculating unit 310 with a second threshold value and determines the character candidate region to the character region according to the compared result. The character region determining unit 320 averages the character region determining scores of the partial regions of the character candidate region and compares the average with the second threshold value. The character region determining unit 320 determines the character candidate region to be the character region when the average is greater than the second threshold value. The second threshold value indicates a minimum value for determining the character candidate region to the character region.

The detected result combining unit 130 selects an image having a largest average from averages of the character region determining scores of the same character region detected from the images having the adjusted sizes and outputs the selected result to the boundary correcting unit 140.

For example, when the character region A is detected from the image whose size is adjusted to level 1 in the image size adjusting unit 100 and the average of the character region determining scores of the detected character region A is 10, and the character region A is detected from the image whose size is adjusted to level 2 in the image size adjusting unit 100 and the average of the character region determining scores of the detected character region A is 8, the detected result combining unit 130 selects the image having the level 1, which has the largest average from the averages of the character region determining scores in the same character region A.

The boundary correcting unit 140 corrects the boundary of the character region included in the image selected by the detected result combining unit 130.

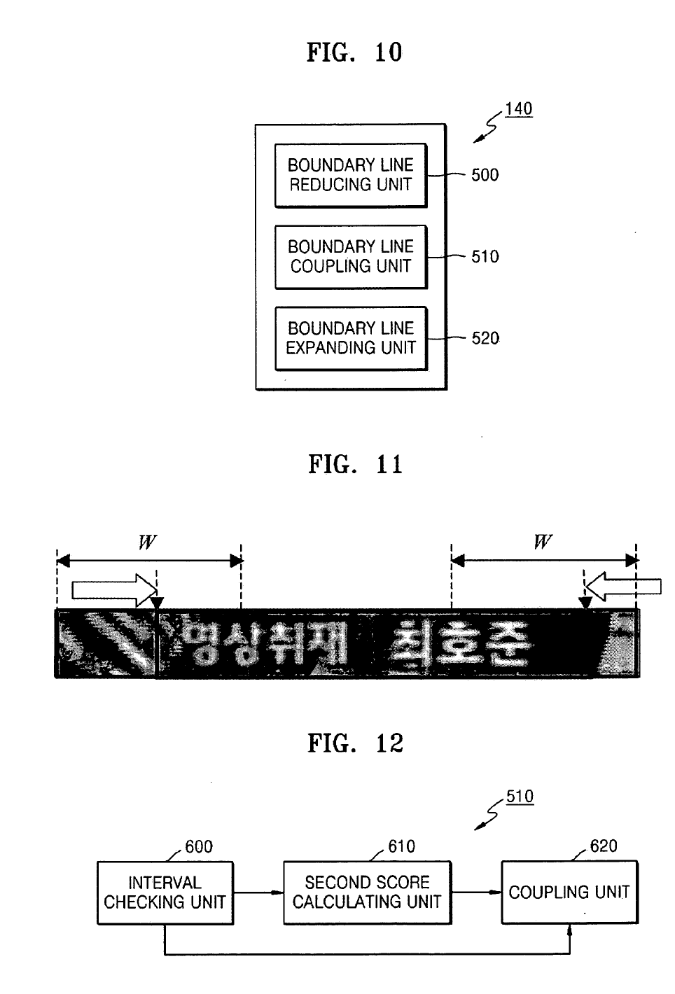

FIG. 10 is a block diagram of the boundary correcting unit 140 illustrated in FIG. 1. The boundary correcting unit 140 includes a boundary line reducing unit 500, a boundary line combining unit 510, and a boundary line expanding unit 520.

The boundary line reducing unit 500 checks whether the character region determining scores of the partial regions in the detected character region is less than a third threshold value and reduces the boundary line of the character region according to the checked result. The third threshold value indicates a minimum value for determining whether the partial regions in the character region are the character region. If the character region determining score of any partial region exceeds the third threshold value, this partial region is the character region and thus the boundary line of the character region is not reduced. However, if the character region determining score of any partial region does not exceed the third threshold value, this partial region is not the character region and thus the boundary line of the character region is reduced.

FIG. 11 illustrates an example of reducing the boundary line of the character region by the boundary line reducing unit 500. As illustrated in FIG. 11, since the partial regions indicated by arrows have the character region determining scores less than the third threshold value W, the boundary line of the character region is reduced.

The boundary line coupling unit 510 checks an interval between the character regions included in the image selected by the detected result combining unit 130 and couples the boundary lines of the character regions.

FIG. 12 is a block diagram of the boundary line coupling unit 510 illustrated in FIG. 10. The boundary line coupling unit 510 includes an interval checking unit 600, a second score calculating unit 610, and a coupling unit 620.

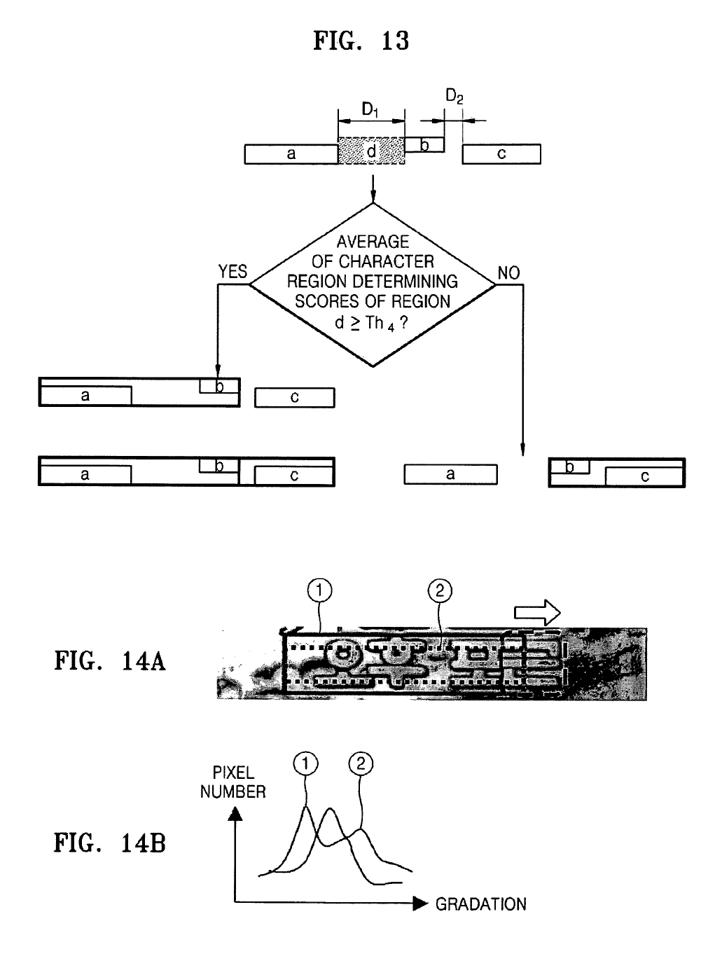

FIG. 13 is a view for explaining components in the boundary line coupling unit 510. As illustrated in FIG. 13, three character regions a, b, and c are detected by the character region checking unit 120.

The interval checking unit 600 checks the interval between the detected character regions and outputs the checked result to the second score calculating unit 610. For example, referring to FIG. 13, the interval checking unit 600 checks an interval D₁ between the character region a and the character region b and checks an interval D₂ between the character region b and the character region c.

When the interval between the character regions is in a predetermined interval range (Dₘᵢₙ≦D≦Dₘₐₓ), the interval checking unit 600 outputs the checked result that the interval is in the predetermined interval range to the second score calculating unit 610. Furthermore, when the interval between the character regions is less than the predetermined interval range (D<Dₘᵢₙ), the interval checking unit 600 outputs the checked result that the interval is less than the predetermined interval range to the coupling unit 620.

The second score calculating unit 610 calculates the character region determining scores of the partial regions having the predetermined size according to the detected result of the interval checking unit 600. For example, referring to FIG. 13, when the interval D₁ between the character region a and the character region b is in the predetermined interval range, the second score calculating unit 610 detects the character region determining scores of division regions of a region d between the character region a and the character region b. The second score calculating unit 610 calculates the character region determining score using Equations 2 through 4.

The coupling unit 620 compares the average of the character region determining scores calculated in the second score calculating unit 610 with a fourth threshold value and couples the boundary lines of the detected character regions according to the compared result. The fourth threshold value indicates a minimum value for coupling the boundary lines of the regions between the character regions. For example, referring to FIG. 13, when the average of the character region determining scores of the region d is greater than the fourth threshold value Th₄, the coupling unit 620 couples the boundary lines of the character region a and the character region b.

The coupling unit 620 couples the boundary lines between the character regions when the detected result that the interval between the character regions is less than the predetermined interval range is received from the interval checking unit 600. For example, referring to FIG. 13, when the checked result that the interval D₂ between the character region b and the character region c is less than the predetermined interval range (D<Dₘᵢₙ), the coupling unit 620 couples the boundary lines between the character region b and the character region c.

The boundary line expanding unit 520 detects a similarity in pixel distribution between the character region included in the image selected by the detected result combining region 130 and a center region of the character region and expands the boundary line of the character region according to the detected similarity and the character region determining score.

FIGS. 14A and 14B are views for explaining a boundary line expanding unit. FIG. 14A illustrates the detected character region (solid-line region: 141) and the center region (dotted-line region: 142) of the detected character region, and FIG. 14B illustrates the pixel distribution 141 of the detected character region and the pixel distribution 142 of the center region of the character region. The center region of the character region is determined to be ½ or ⅓ of the character region, but this is only an example.

As illustrated in FIG. 14, the boundary line expanding unit 520 detects the similarity between the pixel distribution of the character region and the pixel distribution of the center region and checks whether the similarity is greater than a predetermined reference value. The boundary line expanding unit 520 checks whether the average of the character region determining scores of the partial regions of the character region exceeds a fifth threshold value. When the similarity is greater than a predetermined reference value and the average of the character region determining scores exceeds the fifth threshold value, the boundary line expanding unit 520 expands the boundary line of the detected character region. Accordingly, as illustrated in FIG. 14A, the boundary line expanding unit 520 expands the solid-line region which does not adequately include the character region such that the cut character is allowed to be included in the character region.

Hereinafter, a method of detecting a character region in an image according to an embodiment of the present invention will be described more fully with reference to the accompanying drawings.

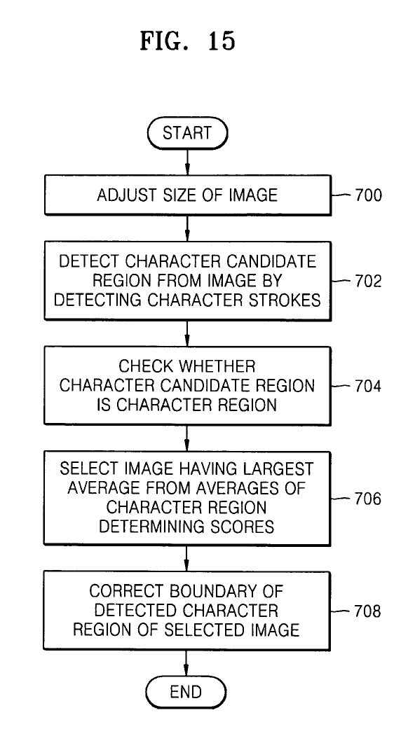

FIG. 15 is a flowchart illustrating a method for detecting a character region in an image according to an embodiment of the present invention.

First, the size of an image is adjusted (operation 700). An original image may be enlarged or reduced.

After operation 700, a character candidate region is detected from the image by detecting character strokes (operation 702).

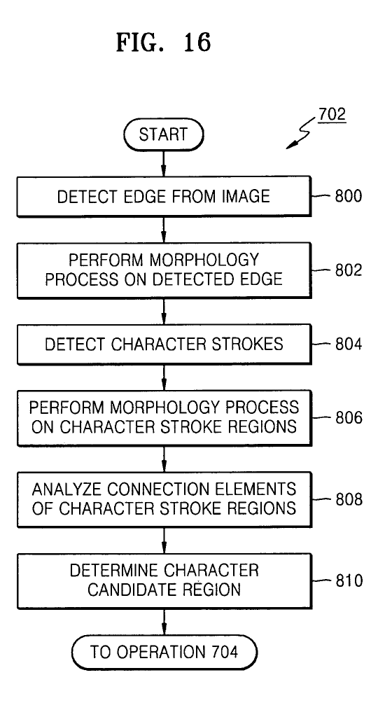

FIG. 16 is a flowchart illustrating operation 702 illustrated in FIG. 15.

An edge is detected from the image (operation 800). The edge corresponds to a portion having a large contrast difference.

After operation 800, the morphology process on the detected edge is performed (operation 802). The morphology process includes dilation and erosion. The dilation represents that a bright portion is more enlarged than the existing image, and the erosion represents that a dark portion is more enlarged than the existing image.

After operation 802, the character strokes are detected from the morphology-processed image (operation 804). As illustrated in FIG. 5, the character stroke filter has a set of a first filter 51, a second filter 52, and a third filter 53, which each has a rectangular shape. However, these conditions are only exemplary and filters having various sizes may be used.

In operation 804, the character strokes are detected using a character stroke filter, while scanning the image.

The character strokes are detected while varying the angle of the character stroke filter. For example, the character strokes are detected from the values of the pixels included in the character stroke filter whenever the character stroke filter rotates by 0 degree, 45 degrees, 90 degrees, and 135 degrees.

Furthermore, the character strokes are detected while varying the size of the character stroke filter. For example, the character strokes are detected while varying the sizes such as the horizontal widths or the vertical widths of the first filter 51, the second filter 52, and the third filter 53.

In operation 804, a region of which a filtering value obtained using Equation 1 exceeds a first threshold value is detected as the character stroke. In equation 1, R(α, d) is the filtering value, α is an angle of the character stroke filter, d is the vertical width of the first filter, m₁⁽¹⁾ is an average of the values of the pixels included in the first filter, m₂⁽¹⁾ is an average of the values of the pixels included in the second filter, m₃⁽¹⁾ is an average of the values of the pixels included in the third filter, and m₁⁽²⁾ is a variance of the values of the pixels included in the first filter.

The first threshold value is a minimum value for determining that the image filtered by the character stroke filter is the character stroke, and uses a value previously obtained through repetitive experiments.

After operation 804, a morphology process on the character stroke regions occupied by the character strokes is performed (operation 806). By the morphology process, the character strokes are dilated or eroded.

After operation 806, when the region occupied by the detected character stroke is the character stroke region, the connection element of the character stroke region is analyzed and the character stroke region is readjusted (operation 808).

In operation 808, when a plurality of character stroke regions are adjacent to one another at the upper, lower, left, and right sides thereof, adjacent character stroke regions are unified into one character stroke region. As illustrated in FIG. 6B, when a plurality of character stroke regions are adjacent to one another at the upper, lower, left, and right sides thereof, adjacent character stroke regions are unified into one character stroke region to form a larger region.

Furthermore, in operation 808, the character stroke region, of which the pixel number is less than a predetermined number, is removed from a character candidate region. As illustrated in FIG. 6B, the character stroke region, of which the pixel number is less than the predetermined number (for example, 300), is removed from the character candidate region. By removing the character stroke region having a small pixel number, the simplified character stroke region is formed as illustrated in FIG. 6B.

After operation 808, the character candidate region is determined by orthogonally projecting the pixels of the readjusted character stroke region in vertical and horizontal directions (operation 810). As illustrated in FIG. 6B, the character stroke region 63 which exceeds a first comparative value R₁ among a histogram result 63 obtained by orthogonally projecting the pixels of the character stroke regions 61 and 62 in the horizontal direction is detected. Also, the character stroke region 65 which exceeds a second comparative value R₂ among a histogram results 64 and 65 obtained by orthogonally projecting the pixels of the character stroke regions 61 and 62 in the vertical direction is detected. Since, the character stroke region 61 which simultaneously satisfies the detected character stroke region 63 and the detected character stroke region 65 is determined as the character candidate region.

After operation 702, it is determined whether the detected character candidate region is the character region (operation 704).

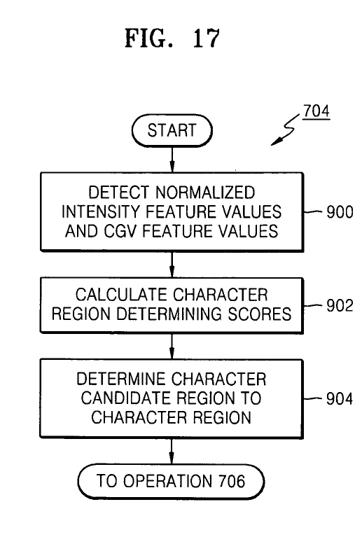

FIG. 17 is a flowchart illustrating operation 704 illustrated in FIG. 15.

Normalized intensity feature values and constant gradient variance feature values are detected from the partial regions obtained by dividing the detected character candidate region by a predetermined size (operation 900). The normalized intensity feature value indicates a normalized value of the intensity of the partial region.

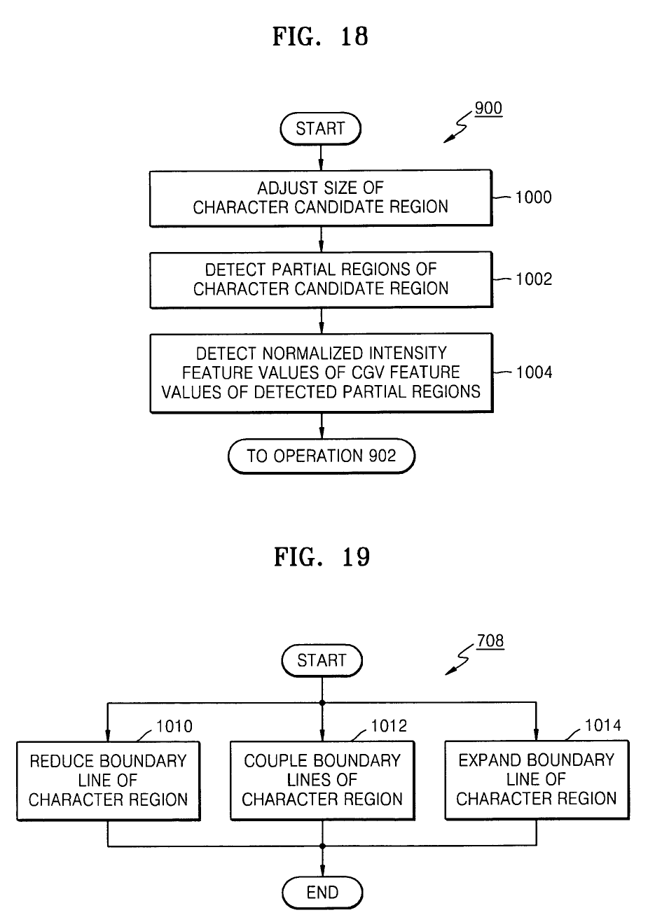

FIG. 18 is a flowchart illustrating operation 900 illustrated in FIG. 17.

The size of the detected character candidate region is adjusted (operation 1000). For example, the size of the detected character candidate region is adjusted to a vertical width of 15 pixels.

After operation 1000, the partial regions of the character candidate region having the adjusted size are detected using a window having a predetermined size (operation 1002). As illustrated in FIG. 9A, the character candidate region is detected by the character candidate region detecting unit 110. FIG. 9B illustrates a procedure of scanning the character candidate region using the window 91 having the predetermined size (for example, 15×15 pixels), and FIG. 9C illustrates the partial regions divided by the window having the predetermined size.

After operation 1002, the normalized intensity feature values and the CGV feature values of the detected partial regions are detected (operation 1004).

The normalized intensity feature value components of the pixels of any partial region are detected using Equation 2. In Equation 2, Nf(s) denotes the normalized intensity feature value component of the pixel s in any partial region, f(s) denotes the intensity value of the pixel s, Vₘᵢₙ denotes a lowest intensity value among the intensity values of the pixels in any partial region, Vₘₐₓ denotes a highest intensity value among the intensity values of the pixels in any partial region, and L denotes a constant for normalizing the intensity value.

For example, if L is a constant of 255, the normalized intensity feature value component is normalized in a range of 0 to 255. If the size of the partial region is 15×15 pixels, the partial region has 225 pixels. Accordingly, the number of the normalized intensity feature value components of each pixel is 225. Thus, 225 normalized intensity feature value components configure the normalized intensity feature value which is a vector value.

The CGV feature value components of the pixels of any partial region are detected using Equation 3. In Equation 3, CGV(s) denotes the CGV feature value component of the pixel s in any partial region, g(s) denotes the gradient size of the pixel s, LM(s) denotes an average of the intensity values of the pixels in a predetermined range from the pixel s, LV(s) denotes a variance of the intensity values of the pixels in the predetermined range from the pixel s, and GV denotes a variance of the intensity values of the pixels in any partial region. The gradient size of the pixel s is obtained through a gradient filter. LM(s) denotes the average of the pixels included in a specific small region when a partial region is divided into small regions (for example, 9×9) centered on each pixel. LV(s) denotes the variance of the pixels included in a specific small region when a partial region is divided into small regions (for example, 9×9) centered on each pixel.

For example, if the size of the partial region is 15×15 pixels, the partial region has 225 pixels. Accordingly, the number of the CGV feature value components of each pixel is 225. Thus, 225 CGV feature value components configure the CGV feature value which is a vector value.

After operation 900, the normalized intensity feature values and the CGV feature values of the partial regions are unified, and character region determining scores of the partial regions are calculated (operation 902).

The character region determining score of any partial region is calculated using Equation 4. In Equation 4, F₀ is the character region determining score of any partial region, F₁ is an output score of support vector machine (SVM) of the normalized intensity feature value of any partial region, F₂ is an output score of support vector machine (SVM) of the CGV feature value of any partial region, P₁ is a pre-trained prior probability of the normalized intensity feature value, and P₂ is a pre-trained prior probability of the CGV feature value.

The prior probability P₁ randomizes classification performance obtained through repetitive training on the normalized intensity feature value f, and the prior probability P₂ randomizes classification performance obtained through repetitive training on the CGV feature value f₂.

In order to calculate the character region determining score, the output score of the support vector machine (SVM) is obtained using Equation 5. In Equation 5, F is the output score of the SVM, αₜ is a weight, yₜ denotes a label, K is Kernel, xₜⱼ is a feature value, z is a variable, and b is a constant.

After operation 902, an average of the calculated character region determining scores is compared with a second threshold value and the character candidate region is determined to the character region according to the compared result (operation 904).

In operation 904, the character region determining scores of the partial regions of the character candidate region are averaged and the average is compared with the second threshold value. In operation 904, when the average is greater than the second threshold value, the character candidate region is determined to the character region. The second threshold value indicates a minimum value for determining the character candidate region to the character region.

After operation 704, an image having a largest average is selected from averages of the character region determining scores of the same character region detected from the images having the adjusted sizes (operation 706). For example, when the character region A is detected from the image whose size is adjusted to level 1 and the average of the character region determining scores of the detected character region A is 10, and the character region A is detected from the image whose size is adjusted to level 2 and the average of the character region determining scores of the detected character region A is 8, in operation 706, the image having the level 1, which has the largest average from the averages of the character region determining scores in the same character region A, is selected.

After operation 706, the boundary of the character region included in the image selected in operation 706 is corrected (operation 708).

FIG. 19 is a flowchart illustrating operation 708 illustrated in FIG. 15.

It is checked whether the character region determining scores of the partial regions of the detected character region are less than a third threshold value and the boundary line of the character region is reduced according to the checked result (operation 1010). The third threshold value indicates a minimum value for determining whether the partial regions of the character region are the character region. If the character region determining score of any partial region exceeds the third threshold value, this partial region is the character region and thus the boundary line of the character region is not reduced. However, if the character region determining score of any partial region does not exceed the third threshold value, this partial region is not the character region and thus the boundary line of the character region is reduced.

As illustrated in FIG. 11, since the partial regions indicated by arrows have the character region determining scores less than the third threshold value, the boundary line of the character region is reduced.

An interval between the detected character regions is checked and the boundary lines of the character regions are coupled (operation 1012).

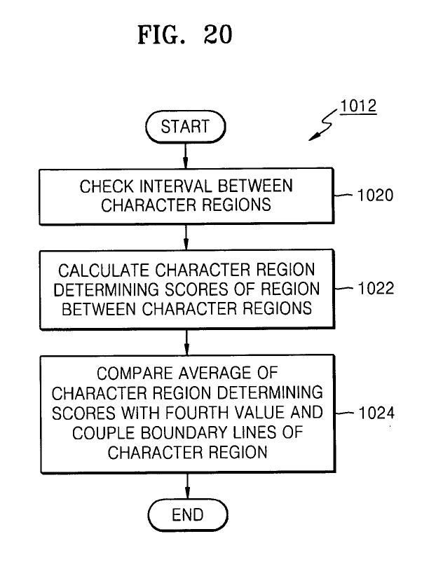

FIG. 20 is a flowchart illustrating operation 1012 illustrated in FIG. 19.

The interval between the detected character regions is checked (operation 1020). For example, referring to FIG. 13, an interval D₁ between the character region a and the character region b and an interval D₂ between the character region b and the character region c are checked.

When the interval between the character regions is in a predetermined interval range (Dₘᵢₙ≦D≦Dₘₐₓ), the checked result that the interval is in the predetermined interval range is output. Furthermore, when the interval between the character regions is less than the predetermined interval range (D<Dₘᵢₙ), the checked result that the interval is less than the predetermined interval range is output.

After operation 1020, the character region determining scores of the partial regions having the predetermined size are calculated (operation 1022).

For example, referring to FIG. 13, when the interval D₁ between the character region a and the character region b is in the predetermined interval range, the character region determining scores of division regions of a region d between the character region a and the character region b are detected. In operation 1022, the character region determining score is obtained using Equations 2 through 4.

After operation 1022, the average of the calculated character region determining scores is compared with a fourth threshold value and the boundary lines of the detected character regions are coupled according to the compared result. The fourth threshold value indicates a minimum value for coupling the boundary lines of the regions between the character regions. For example, referring to FIG. 13, when the average of the character region determining scores of the region d is greater than the fourth threshold value Th₄, the boundary lines of the character region a and the character region b are coupled.

When the detected result that the interval between the character regions is less than the predetermined interval range is received, the boundary lines between the character regions are coupled. For example, referring to FIG. 13, when the checked result that the interval D₂ between the character region b and the character region c is less than the predetermined interval range (D<Dₘᵢₙ), the boundary lines between the character region b and the character region c are coupled.

A similarity in pixel distribution between the detected character region and a center region of the detected character region is detected and the boundary line of the detected character region expands according to the detected similarity (operation 1014).

As illustrated in FIG. 14A, the similarity between the pixel distribution of the character region and the pixel distribution of the center region is detected and it is checked whether the similarity is greater than a predetermined reference value. It is checked whether the average of the character region determining scores of the partial regions of the character region exceeds a fifth threshold value. When the similarity is greater than the predetermined reference value and the average of the character region determining scores exceeds the fifth threshold value, the boundary line of the detected character region expands. Accordingly, as illustrated in FIG. 14A, the solid-line region which does not adequately include the character region is expands such that the cut character is included in the character region.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the apparatus and method for detecting the character region in the image, since the stroke filter is used for detecting the character candidate region, it is possible to efficiently extract the character candidate region.

According to the apparatus and method for detecting the character region in the image, it is possible to provide more precise determining performance in combining the feature values and determining the character region.

According to the apparatus and method for detecting the character region in the image, it is possible to detect an optimal character region by correcting the detected character region.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for detecting a character region in an image, comprising:
a character candidate region detecting unit which detects a character candidate region from the image by detecting character strokes; and
a character region checking unit which checks whether the detected character candidate region is the character region in response to the detected result of the character candidate region detecting unit.

2. The apparatus of claim 1, wherein the character candidate region detecting unit comprises:
a character stroke detecting unit which detects the character strokes from the image;
a connection element analyzing unit which analyzes connection elements for each character stroke region of the detected character strokes and readjusts the character stroke regions; and
a candidate region determining unit which determines the character candidate region by orthogonally projecting pixels of the readjusted character stroke regions in vertical and horizontal directions.

3. The apparatus of claim 2, wherein the character stroke detecting unit detects the character strokes using a character stroke filter while scanning the image.

4. The apparatus of claim 3, wherein the character stroke detecting unit detects the character strokes while varying the angle of the character stroke filter.

5. The apparatus of claim 3, wherein the character stroke detecting unit detects the character strokes while varying the size of the character stroke filter.

6. The apparatus of claim 3, wherein the character stroke filter comprises:
a first filter;
a second filter; and
a third filter,
wherein each of the first, second and third filters have a rectangular shape.

7. The apparatus of claim 6, wherein the character stroke detecting unit detects as the character strokes a region in which a filtering value obtained by
$${R}_{1} ( α , d ) = \frac{1}{\sqrt{{m}_{1}^{( 2 )}}} [ \vert {m}_{1}^{( 1 )} - {m}_{2}^{( 1 )} \vert + \vert {m}_{1}^{( 1 )} - {m}_{3}^{( 1 )} \vert - \vert {m}_{2}^{( 1 )} - {m}_{3}^{( 1 )} \vert ]$$
exceeds a first threshold value,
where, R(α, d) is the filtering value, α is an angle of the character stroke filter, d is the vertical width of the first filter, m₁⁽¹⁾ is an average of the values of the pixels included in the first filter, m₂⁽¹⁾ is an average of the values of the pixels included in the second filter, m₃⁽¹⁾ is an average of the values of the pixels included in the third filter, and m₁⁽²⁾ is a variance of the values of the pixels included in the first filter.

8. The apparatus of claim 2, wherein the connection element analyzing unit unifies adjacent character stroke regions into one character stroke region when a plurality of character stroke regions are adjacent to one another at the upper, lower, left, and right sides thereof.

9. The apparatus of claim 2, wherein the connection element analyzing unit excludes the character stroke region from the character candidate region, if pixel number of the character stroke region is less than a predetermined number.

10. The apparatus of claim 2, wherein the candidate region determining unit determines the character stroke region which histogram results by orthogonally projecting the pixels of the character stroke region in the horizontal direction and the vertical direction exceed a first comparative value and a second comparative value as the character candidate region.

11. The apparatus of claim 2, wherein the character candidate region detecting unit further comprises an edge detecting unit which detects an edge from the image.

12. The apparatus of claim 11, wherein the character candidate region detecting unit further comprises a first morphology processing unit which performs a morphology process on the detected edge.

13. The apparatus of claim 2, wherein the character candidate region detecting unit further comprises a second morphology processing unit which performs a morphology process on the detected character strokes.

14. The apparatus of claim 1, wherein the character region checking unit comprises:
a feature value detecting unit which detects normalized intensity feature values and constant gradient variance (CGV) feature values of partial regions obtained by dividing the detected character candidate region by a predetermined size; and
a first score calculating unit which unifies the normalized intensity feature values and the CGV feature values of the partial regions and calculates character region determining scores of the partial regions; and
a character region determining unit which compares an average of the calculated character region determining scores with a second threshold value and determines the character candidate region to the character region according to the compared result.

15. The apparatus of claim 14, wherein the feature value detecting unit comprises:
a candidate region size adjusting unit which adjusts the size of the detected character candidate region;
a partial region detecting unit which detects the partial regions of the character candidate region having the adjusted size using a window having a predetermined size;
a normalized intensity feature value detecting unit which detects the normalized intensity feature values of the detected partial regions; and
a CGV feature value detecting unit which detects the CGV feature values of the detected partial regions.

16. The apparatus of claim 15, wherein the normalized intensity feature value detecting unit detects normalized intensity feature value components of the pixels of any partial region using
Nf(s)=(f(s)−Vₘᵢₙ)/(Vₘₐₓ−Vₘᵢₙ)*L
where, Nf(s) is the normalized intensity feature value component of the pixel s in any partial region, f(s) is the intensity value of the pixel s, Vₘᵢₙ denotes a lowest intensity value among the intensity values of the pixels in any partial region, Vₘₐₓ is a highest intensity value among the intensity values of the pixels in any partial region, and L is a constant for normalizing the intensity value.

17. The apparatus of claim 15, wherein the CGV feature value detecting unit detects the CGV feature value components of the pixels of any partial region using
$$CGV ( s ) = ( g ( s ) - LM ( s ) ) \sqrt{\frac{GV}{LV ( s )}}$$
where, CGV(s) is the CGV feature value component of the pixel s in any partial region, g(s) is the gradient size of the pixel s, LM(s) is an average of the intensity values of the pixels in a predetermined range from the pixel s, LV(s) is a variance of the intensity values of the pixels in the predetermined range from the pixel s, and GV is a variance of the intensity values of the pixels in any partial region.

18. The apparatus of claim 14, wherein the first score calculating unit calculates the character region determining score of any partial region using
F₀=P₁F₁+P₂F₂
where, F₀ is the character region determining score of any partial region, F₁ is an output score of support vector machine (SVM) of the normalized intensity feature value of any partial region, F₂ is an output score of support vector machine (SVM) of the CGV feature value of any partial region, P₁ is a pre-trained prior probability of the normalized intensity feature value, and P₂ is a pre-trained prior probability of the CGV feature value.

19. The apparatus of claim 1, further comprising:
an image size adjusting unit which adjusts the size of the image; and
a detected result combining unit which selects an image having the largest average from the averages of the character region determining scores of the same character region detected from the images having the adjusted sizes.

20. The apparatus of claim 1, further comprising a boundary correcting unit which corrects the boundary of the detected character region.

21. The apparatus of claim 20, wherein the boundary correcting unit comprises a boundary line reducing unit which checks whether the character region determining scores of partial regions obtained by dividing the detected character region by a predetermined size are less than a third threshold value and reduces the boundary line of the character region according to the checked result.

22. The apparatus of claim 20, wherein the boundary correcting unit comprises a boundary line coupling unit which checks an interval between the detected character regions and couples the boundary lines of the detected character regions.

23. The apparatus of claim 22, wherein the boundary line coupling unit comprises:
an interval checking unit which checks an interval between the detected character regions;
a second score calculating unit which calculates the character region determining scores of the partial regions obtained by dividing a region between the character regions by a predetermined size according to the checked result of the interval checking unit; and
a coupling unit which compares an average of the calculated character region determining scores with a fourth threshold value and couples the boundary lines of the detected character regions according to the compared result.

24. The apparatus of claim 20, wherein the boundary correcting unit comprises a boundary line expanding unit which detects a similarity in pixel distribution between the detected character region and a center region of the detected character region and expands the boundary line of the detected character region according to the detected similarity.

25. The apparatus of claim 24, wherein the boundary line expanding unit expands the boundary line of the detected character region when the detected similarity exceeds a predetermined reference value and an average of the character region determining scores of the partial regions exceeds a fifth threshold value.

26. A method of detecting a character region in an image, comprising:
detecting a character candidate region from the image by detecting character strokes; and
checking whether the detected character candidate region is the character region.

27. The method of claim 26, wherein the detecting of the character candidate region comprises:
detecting the character strokes from the image;
analyzing connection elements for each character stroke region of the detected character strokes and readjusting the character stroke regions; and
determining the character candidate region by orthogonally projecting pixels of the readjusted character stroke regions in vertical and horizontal directions.

28. The method of claim 27, wherein, in the detecting of the character strokes, the character strokes are detected using a character stroke filter while scanning the image.

29. The method of claim 28, wherein, in the detecting of the character strokes, the character strokes are detected while varying the angle of the character stroke filter.

30. The method of claim 28, wherein, in the detecting of the character strokes, the character strokes are detected while varying the size of the character stroke filter.

31. The method of claim 28, wherein the character stroke filter comprises:
a first filter;
a second filter; and
a third filter,
wherein each of the first, second and third filters have a rectangular shape.

32. The method of claim 31, wherein, in the detecting of the character strokes, a region in which a filtering value obtained by
$${R}_{1} ( α , d ) = \frac{1}{\sqrt{{m}_{1}^{( 2 )}}} [ \vert {m}_{1}^{( 1 )} - {m}_{2}^{( 1 )} \vert + \vert {m}_{1}^{( 1 )} - {m}_{3}^{( 1 )} \vert - \vert {m}_{2}^{( 1 )} - {m}_{3}^{( 1 )} \vert ]$$
exceeds a first threshold value is detected as the character strokes,
where, R(α, d) is the filtering value, α denotes an angle of the character stroke filter, d is the vertical width of the first filter, m₁⁽¹⁾ is an average of the values of the pixels included in the first filter, m₂⁽¹⁾ is an average of the values of the pixels included in the second filter, m₃⁽¹⁾ is an average of the values of the pixels included in the third filter, and m₁⁽²⁾ is a variance of the values of the pixels included in the first filter.

33. The method of claim 27, wherein, in the analyzing of the connection elements, adjacent character stroke regions are unified into one character stroke region when a plurality of character stroke regions are adjacent to one another at the upper, lower, left, and right sides thereof.

34. The method of claim 27, wherein in the analyzing of the connection elements, the character stroke region is excluded from the character candidate region, if pixel number of the character stroke region is less than a predetermined number.

35. The method of claim 27, wherein, in the determining of the character candidate region, determining the character stroke region which histogram results by orthogonally projecting the pixels of the character stroke region in the horizontal direction and the vertical direction exceed a first comparative value and a second comparative value as the character candidate region.

36. The method of claim 27, wherein the detecting of the character candidate region further comprises detecting an edge from the image,
wherein the detecting of the character strokes is performed after the detecting the edge.

37. The method of claim 36, wherein the detecting of the character candidate region further comprises performing a morphology process on the detected edge,
wherein the detecting of the character strokes is performed after performing the morphology process.

38. The method of claim 27, wherein the detecting of the character candidate region further comprises performing a morphology process on the detected character strokes,
wherein the detecting of the character strokes is performed after the performing the morphology process.

39. The method of claim 26, wherein the checking of whether the detected character candidate region is the character region comprises:
detecting normalized intensity feature values and constant gradient variance (CGV) feature values of partial regions obtained by dividing the detected character candidate region by a predetermined size; and
unifying the normalized intensity feature values and the CGV feature values of the partial regions and calculating character region determining scores of the partial regions; and
comparing an average of the calculated character region determining scores with a second threshold value and determining the character candidate region to the character region according to the compared result.

40. The method of claim 39, wherein the detecting of the feature values comprises:
adjusting the size of the detected character candidate region;
detecting the partial regions of the character candidate region having the adjusted size using a window having a predetermined size;
detecting the normalized intensity feature values and the CGV feature values of the detected partial regions.

41. The method of claim 40, wherein, in the detecting of the normalized intensity feature values and the CGV feature values, normalized intensity feature value components of the pixels of any partial region are detected using
Nf(s)=(f(s)−Vₘᵢₙ)/(Vₘₐₓ−Vₘᵢₙ)*L
where, Nf(s) is the normalized intensity feature value component of the pixel s in any partial region, f(s) is the intensity value of the pixel s, Vₘᵢₙ is a lowest intensity value among the intensity values of the pixels in any partial region, Vₘₐₓ is a highest intensity value among the intensity values of the pixels in any partial region, and L is a constant for normalizing the intensity value.

42. The method of claim 40, wherein, in the detecting of the normalized intensity feature values and the CGV feature values the CGV feature value components of the pixels of any partial region are detected using
$$CGV ( s ) = ( g ( s ) - LM ( s ) ) \sqrt{\frac{GV}{LV ( s )}}$$
where, CGV(s) is the CGV feature value component of the pixel s in any partial region, g(s) denotes the gradient size of the pixel s, LM(s) is an average of the intensity values of the pixels in a predetermined range from the pixel s, LV(s) is a variance of the intensity values of the pixels in the predetermined range from the pixel s, and GV is a variance of the intensity values of the pixels in any partial region.

43. The method of claim 39, wherein, in the unifying of the normalized intensity feature values and the CGV feature values, the character region determining score of any partial region is calculated using
F₀=P₁F₁+P₂F₂
where, F₀ is the character region determining score of any partial region, F₁ is an output score of support vector machine (SVM) of the normalized intensity feature value of any partial region, F₂ is an output score of support vector machine (SVM) of the CGV feature value of any partial region, P₁ is a pre-trained prior probability of the normalized intensity feature value, and P₂ is a pre-trained prior probability of the CGV feature value.

44. The method of claim 26, further comprising:
adjusting the size of the image; and
selecting an image having the largest average from the averages of the character region determining scores of the same character region detected from the images having the adjusted sizes.

45. The method of claim 26, further comprising correcting the boundary of the detected character region.

46. The method of claim 45, wherein the correcting of the boundary comprises checking whether the character region determining scores of partial regions obtained by dividing the detected character region by a predetermined size are less than a third threshold value and reducing the boundary line of the character region according to the checked result.

47. The method of claim 45, wherein the correcting of the boundary comprises checking an interval between the detected character regions and coupling the boundary lines of the detected character regions.

48. The method of claim 47, wherein the checking of the interval comprises:
checking an interval between the detected character regions;
calculating the character region determining scores of the partial regions obtained by dividing a region between the character regions by a predetermined size; and
comparing an average of the calculated character region determining scores with a fourth threshold value and coupling the boundary lines of the detected character regions according to the compared result.

49. The method of claim 45, wherein the correcting of the boundary comprises detecting a similarity in pixel distribution between the detected character region and a center region of the detected character region and expanding the boundary line of the detected character region according to the detected similarity.

50. The method of claim 49, wherein, in the detecting of the similarity, the boundary line of the detected character region expands when the detected similarity exceeds a predetermined reference value and an average of the character region determining scores of the partial regions exceeds a fifth threshold value.

51. A computer-readable medium having embodied thereon a computer program for performing the method of claim 26.
